(19) United States
(12) Patent Application Publication
(10) Pub. No.: US 2009/0036702 A1
(43) Pub. Date: Feb. 5, 2009

(54) PRODUCTION OF ORGANOSILANES IN THE PRESENCE OF IRIDIUM-CATALYSTS AND COCATALYSTS

(75) Inventors: Frank Baumann, Tittmoning (DE); Marco Hofmann, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/718,164

(22) PCT Filed: Oct. 20, 2005
(86) PCT No.: PCT/EP2005/011300

§ 371 Date: Apr. 27, 2007

(30) Foreign Application Priority Data
Oct. 28, 2004 (DE) 10 2004 052 424.6
Jun. 30, 2005 (DE) 10 2005 030 581.4

(51) Int. Cl. C07F 7/14

(52) U.S. Cl. 556/476

(57) ABSTRACT

Organosilanes are prepared efficiently by hydrosilylation of an alkene in the presence of iridium compounds as catalysts and an inorganic, metal organic, or organic oxidant as cocatalyst. side reactions and catalyst deactivation are thereby minimized.

The invention relates to a process for preparing organosilanes by hydrosilylation of alkenes by means of silanes having Si-bonded hydrogen atoms in the presence of iridium compounds as catalysts and cocatalysts.

Substituted alkylsilanes are of tremendous economic interest for a wide variety of fields. They are used, for example, as bonding agents, as crosslinkers or as precursors for further chemical reactions such as hydrolyses or nucleophilic substitution reactions.

The platinum- or rhodium-catalyzed hydrosilylation of unsaturated, halogen-substituted compounds has been studied many times before. The product yields are often very low, viz. from 20 to 45%, which can be attributed to a considerable level of secondary reactions. One major secondary reaction which occurs here is replacement of a hydrogen atom by a halogen atom on the silicon.

According to U.S. Pat. No. 4,658,050, iridium catalysts having diene ligands are used in the hydrosilylation of allyl compounds by means of alkoxy-substituted silanes. Chemical Abstracts 123:340390 describes the hydrosilylation of allyl halides by means of chlorodimethylsilane in the presence of iridium catalysts having diene ligands. Disadvantages of this process are either moderate yields, an uneconomically high catalyst concentration and/or a very short life of the catalyst.

EP-A-1 156 052 and U.S. Pat. No. 6,388,119 (corresponding to DE-C-100 53 037) and DE-C 102 32 663 describe the addition of additional diene ligands to extend the catalyst life. However, these cocatalysts/catalysts combinations have the disadvantage that they very quickly lose their hydrosilylation activity as soon as the silane starting material having Si—H groups is present in molar excess over the olefin starting material, viz. the alkene. These fluctuations in the starting mixture occur particularly in continuous, running production processes and cessation of the reaction occurs. This poses a great safety risk.

It is therefore an object of the invention to develop a catalyst system which has a longer life and ensures high product yields and purities, at the same time avoids the above-described disadvantages and thus takes account of process and safety aspects.

The invention provides a process for preparing silanes of the general formula I

R⁶R⁵CH—R⁴CH—SiR¹R²R³ (1),

in which silanes of the general formula II

HSiR¹R²R³ (II)

are reacted with alkenes or alkynes of the general formula III

R⁶R⁵C═CHR⁴ (III),

in the presence of iridium compounds as catalysts and in the presence of cocatalysts selected from the group consisting of
inorganic oxidants selected from the group consisting of oxygen, chlorine, bromine, iodine, peracids, peroxides, bromate, chlorate, iodate, perchlorate, potassium chromate, potassium dichromate, potassium permanganate, sodium peroxodisulfate, potassium perrhenate and potassium hexacyanoferrate(III);
metal-organic oxidants selected from the group consisting of ferricinium, [Ru(bipyridine)₃]³⁺ and [Fe(phenanthroline)₃]³⁺; and
organic oxidants selected from the group consisting of aldehydes, acetone, methyl isobutyl ketone, acetyl-acetone, 1,4-cyclohexanedione, 1,3-cyclohexanedione, 1,2-cyclohexanedione, 1,9-cyclohexadecanedione, benzyl, triketones, naphthoquinone, organic peroxides and peracids, crown ethers, phosphane oxides, sulfones, tritylium salts and tropylium salts,
with the cocatalysts being used in amounts of from 0.5% by weight to 5.0% by weight, based on the total weight of the components of the general formulae (II) and (III) used,
where
R¹, R², R³ are each a monovalent Si—C-bonded, unsubstituted or halogen-substituted C₁-C₁₈-hydrocarbon, chlorine or C₁-C₁₈-alkoxy radical,
R⁴, R⁵, R⁶ are each a hydrogen atom, a monovalent unsubstituted or F—, Cl—, OR—, NR₂—, CN— or NCO-substituted C₁-C₁₈-hydrocarbon, chlorine, fluorine or C₁-C₁₈-alkoxy radical, where 2 radicals from among R⁴, R⁵, R⁶ together with the carbon atoms to which they are bound may form a cyclic radical,
   or R⁴ and R⁵ can together represent a bond between the carbon atoms to which they are bound, and
R is a hydrogen atom or a monovalent C₁-C₁₈-hydro-carbon radical.

Preference is given to using iridium compounds of the general formula IV

[(diene)IrX]₂ (IV),

where
X is a halogen atom such as chlorine, bromine, or iodine or a hydroxy group or a methoxy group and
diene is an unsubstituted or F—, Cl—, OR—, NR₂—, CN— or NCO-substituted C₄-C₅₀-hydrocarbon compound which has at least two ethylenic C═C double bonds, where R is as defined above,
   as catalysts.

C₁-C₁₈-hydrocarbon radicals R¹, R², R³ are preferably alkyl, alkenyl, cycloalkyl or aryl radicals. R¹, R², R³ preferably have not more than 10, in particular not more than 6, carbon atoms. R¹, R², R³ are preferably straight-chain or branched C₁-C₆-alkyl radicals or C₁-C₆-alkoxy radicals.

Preferred halogen substituents are fluorine and chlorine. Particularly preferred radicals R¹, R², R³ are the radicals methyl, ethyl, methoxy, ethoxy, chlorine, phenyl and vinyl.

Preferred examples of silanes of the formula II are chlorosilanes and particular preference is given to dimethylchlorosilane.

Hydrocarbon radicals R⁴, R⁵, R⁶ are preferably alkyl, alkenyl, cycloalkyl or aryl radicals. Preference is given to not more than one of the hydrocarbon radicals R⁴, R⁵, R⁶ being an alkoxy radical. R⁵, R⁶ preferably have not more than 10, in particular not more than 6, carbon atoms. R⁵, R⁶ are preferably straight-chain or branched C₁-C₆-alkyl radicals, chlorine-substituted C₁-C₆-alkyl radicals or C₁-C₆-alkoxy radicals. Particularly preferred radicals R⁵, R⁶ are the radicals hydrogen, methyl, ethyl, chlorine, phenyl and chloromethyl.

Hydrocarbon radical R⁴ preferably has not more than 6, in particular not more than 2, carbon atoms. Particularly preferred radicals R⁴ are the radicals hydrogen, methyl, ethyl.

Hydrocarbon radical R preferably has not more than 6, in particular not more than 2, carbon atoms.

A preferred example of an alkene of the formula III is allyl chloride.

In the process of the invention, it is possible to use an alkyne in place of an alkene, but this is not preferred. The radicals R⁴ and R⁵ then together represent a bond between the two carbon atoms to which they are bound in the formula III and the alkyne has the formula R⁶C≡CH (R⁶ is as defined above). This gives a silane of the formula (I) in which the two radicals R⁴ and R⁵ then likewise together represent a bond between the two carbon atoms to which they are bound.

The ligands denoted as diene can comprise not only the molecule units having ethylenic C═C double bonds but also alkyl, cycloalkyl or aryl units. The dienes preferably have from 6 to 12 carbon atoms. Preference is given to monocyclic or bicyclic dienes. Preferred examples of dienes are butadiene, 1,3-hexadiene, 1,4-hexadiene, 1,5-hexadiene, isoprene, 1,3-cyclo-hexadiene, 1,3-cyclooctadiene, 1,4-cyclooctadiene, 1,5-cyclooctadiene and norbornadiene.

In a particularly preferred case, [(cyclo-octa-1c,5c-diene)IrCl]₂ is used as catalyst of the general formula IV.

Examples of aldehydes as cocatalysts are benzaldehyde, acetaldehyde and cinnamaldehyde.

Examples of triketones as cocatalysts are 1,5-diphenyl-1,3,5-pentanetrione and 2,2,4,4,6,6-hexa-methyl-1,3,5-hexanetrione.

Examples of phosphane oxides as cocatalysts are triphenylphosphane oxide and trimethylphosphane oxide. Examples of sulfones as cocatalysts are dimethyl sulfone and diphenyl sulfone.

An example of a tritylium salt as cocatalysts is [Ph₃C] [BF₄] and an example of a tropylium salt is [C₇H₇] [BF₄].

Preferred cocatalysts are organic oxidants such as aldehydes, acetone, methyl isobutyl ketone, acetylacetones, 1,4-cyclohexanedione, 1,3-cyclohexane-dione, 1,2-cyclohexanedione, 1,9-cylcohexadecanedione, benzyl, naphthoquinone and organic peroxides and inorganic peroxides.

The alkene of the general formula III is preferably reacted in an excess of from 0.01 to 100 mol %, particularly preferably from 0.1 to 25 mol %, based on the silane component of the general formula II.

The iridium compound used as catalyst, preferably the iridium compound of the general formula IV, is preferably used in amounts of from 3 to 10 000 ppm by weight, preferably from 20 to 1000 ppm by weight, particularly preferably from 50 to 500 ppm by weight, in each case calculated as elemental iridium and based on the total weight of the components of the formulae II and III present in the reaction mixture.

The oxidative cocatalyst is preferably used in amounts of from 0.5 to 2.5% by weight, more preferably from 1.0 to 2.0% by weight, in each case based on the total weight of the components of the formulae II and III present in the reaction mixture.

The process of the invention can be carried out in the presence or absence of aprotic solvents. If aprotic solvents are used, solvents or solvent mixtures having a boiling point or boiling range of up to 120° C. at 0.1 MPa are preferred. Examples of such solvents are chlorinated hydrocarbons such as dichloromethane, trichloromethane, tetrachloromethane, 1,2-dichloro-ethane, trichloroethylene; hydrocarbons such as pentane, n-hexane, hexane isomer mixtures, heptane, octane, naptha, petroleum ether, benzene, toluene, xylenes; esters such as ethyl acetate, butyl acetate, propyl propionate, ethyl butyrate, ethyl isobutyrate; carbon disulfide and nitrobenzene, and mixtures of these solvents.

Preference is given to using no aprotic solvents.

The target product of the general formula I can also be used as aprotic solvent in the process of the invention, i.e. the reacted reaction mixture can also serve as solvent. This has the advantage that no further substances are introduced into the reaction system.

For example, the reaction component of the general formula III is placed together with iridium catalyst of the general formula IV and, if appropriate, the oxidative cocatalyst in a reaction vessel and the reaction component of the general formula II, if appropriate in admixture with the oxidative cocatalyst, is introduced while stirring.

The process of the invention is preferably carried out at a temperature of from 0 to 200° C., more preferably from 20 to 100° C., particularly preferably from 25 to 40° C. The process of the invention can be carried out at the pressure of the surrounding atmosphere, i.e. about 0.10 MPa, or else at higher or lower pressures. If the process of the invention is carried out at superatmospheric pressures, preference is given to using a pressure of from 2 to 20 bar, particularly preferably from 6 to 12 bar.

The process of the invention can be carried out batchwise, semicontinuously or fully continuously or as a reactive distillation.

A preferred embodiment is a continuous process for preparing silanes of the general formula I

R⁶R⁵CH—R⁴—CH—SiR¹R²R³ (I),

in which silanes of the general formula II

HSiR¹R²R³ (II),

are reacted continuously with alkenes or alkynes of the general formula III

R⁶R⁵C═CHR⁴ (III),

in the presence of the iridium compounds as catalysts
and in the presence of the cocatalysts according to the invention, with the cocatalysts being used in amounts of from 0.5% by weight to 5.0% by weight, based on the total weight of the components of the general formulae (II) and (III) used,
where
R¹, R², R³, R⁴, R⁵, R⁶ are as defined above and
the reaction temperature is from 0° C. to 40° C., preferably from 20° C. to 40° C., and the temperature of the reaction mixture is maintained at these temperatures.

A preferred process comprises starting the reaction at from 35° C. to 40° C. and reducing the reaction temperature to from 20° C. to 30° C. after the exothermic hydrosilylation reaction has commenced.

The continuous process is preferably carried out at the pressure of the surrounding atmosphere, i.e. about 0.10 MPa, but can also be carried out at higher or lower pressures. The reaction pressure can therefore preferably be from 0.10 to 50 MPa, more preferably from 0.10 to 2.0 MPa.

The continuous process gives the silane of the general formula (I) in high yields and excellent purity.

In the continuous process, the target products of the general formula (I) are obtained in yields of preferably from 90% to 99%, based on the silane used, preferably chlorosilane, of the formula (II) when using very small amounts of catalyst. The allyl chloride excess can preferably be reduced significantly in the continuous process. The formation of the corresponding silane by-products as a result of hydrogen-chlorine exchange can be decreased significantly. In addition, the process is easy to control and safer to carry out.

Suitable industrial apparatuses for carrying out the process are all customary reactors for continuous reactions, e.g. tube and loop reactors and also continuously operated stirred reactors or combinations of these types of reactor, e.g. loop-tube reactor, tube-loop-tube reactor, tube-stirred vessel reactor, continuous stirred tank reactor, continuous reactive distillation under reduced pressure at low temperatures, etc., with the tube reactors being able to have static and/or dynamic stirring devices. Likewise suitable are microreactors having channel sizes of from 1 micron to a few millimeters. The various reactors have to have a suitable cooling facility in order to remove the heat evolved in the exothermic reaction quantitatively and thus keep the reactor temperature or reaction temperature at less than 40° C. Suitable cooling devices are, for example, internal cooling coils, tube heat exchangers or plate heat exchangers in the loop circuit, etc.

As an alternative or to aid removal of heat from the reactor, one or all starting materials can be precooled by means of suitable heat exchangers, preferably to temperatures of from −20° C. to 30° C., more preferably from 0° C. to 15° C., in the continuous process. Suitable heat exchangers are once again plate heat exchangers or tube heat exchangers, etc., and micro heat exchangers having a channel cross section of from 1 micron to 10 millimeters.

As regards the order in which the reaction components are introduced, all conceivable combinations are in principle possible; in particular, the components can be introduced into the reactor in partly premixed form. Preference is here given to premixing the iridium catalyst with the cocatalyst and the alkene of the formula (III). The iridium catalyst is preferably not in an environment in which an excess of silane of the formula (II) over the alkene of the formula (III) is present, since the iridium catalyst can otherwise display deactivation.

A further possibility is premixing of all components, if appropriate with cooling, in a continuous active or static mixing device, e.g. static mixing elements, pentax or planet mixers or micromixing elements, with subsequent transfer of this reaction mixture into a downstream reaction section which is once again designed as a continuous reactor, e.g. as tube reactor, loop reactor, etc.

For example, the silanes of the formula (II), if appropriate in a mixture with the cocatalyst, are, in the continuous process, fed continuously via one line and a mixture of alkenes of the formula (III), iridium catalyst and cocatalyst are fed continuously via another line into a reactor, e.g. a loop reactor or continuous stirred vessel. Here, the temperature is preferably reduced continuously from an initial 35° C. down to 30° C.

In another embodiment, the target product of the formula (I) or an aprotic solvent together with the iridium catalyst and the cocatalyst are placed in the reactor at 35° C. for starting up the reactor and a mixture of alkene of the formula (III) and, if appropriate, cocatalyst is introduced continuously via a line and the silane of the formula (II) is introduced continuously via another line. After the reaction commences, the reaction mixture is cooled to 25° C.

In the continuous process, the silane of the general formula (I) formed after the reaction is discharged continuously from the reactor.

The mean residence times of the reactor contents are preferably from 0.5 to 60 minutes and are dependent on the respective reaction temperature.

In the following examples, all quantities and percentages are by weight, all pressures are 0.10 MPa (abs.) and all temperatures are 20° C., unless indicated otherwise.

### EXAMPLES 1 TO 14 (E1-E14) and Comparative Experiments 1 to 4 (C1-C4)

43 g (0.562 mol) of allyl chloride and the amount indicated in table 1 of [(COD)IrCl]₂=di-μ-chlorobis[(cycloocta-1c,5c-diene) iridium(I)] were placed in a 250 ml flask fitted with a reflux condenser and the mixture was stirred at room temperature (=25° C.) under a nitrogen atmosphere for 10 minutes. The cocatalyst indicated in table 1 is then added in an amount corresponding to the first half of the amount indicated in table 1 to the starting mixture. The amount indicated in table 1 of dimethylchlorosilane (HM2) containing the second half of the amount of cocatalyst is subsequently added dropwise over a period of 20 minutes while stirring. This results in a rise in the reaction temperature to 90° C. After the addition is complete, the mixture is stirred for another 30 minutes without external heating.

In comparative experiment 1, no cocatalyst is added. In comparative experiment 2, a diene, viz. COD (=1,5-cyclooctadiene), is used as cocatalyst. In comparative experiments 3 and 4, acetone is used as cocatalyst in amounts of about 10% by weight and 15% by weight, respectively, based on the total weight of silane (HM2) and allyl chloride.

The yields in the comparative experiments are significantly worse than in the examples according to the invention.

TABLE 1

| | | | | | Yield |
|---|---|---|---|---|---|
| | | | | | of target |
| | [(COD)IrCl]₂ | Silane | | Cocatalyst | product |
| | in [mg] | (HM2) in [g] | Cocatalyst | in [g] | in [%]* |
| C1 | 70 | 56 | — | — | 33 |
| C2 | 70 | 56 | Diene: COD | 2 | 45 |
| C3 | 70 | 56 | Acetone | 9.9 | 53 |
| C4 | 70 | 56 | Acetone | 14.85 | 47 |
| E1 | 70 | 56 | Acetone | 2 | 70 |
| E2 | 35 | 56 | Acetone | 2 | 67 |
| E3 | 70 | 56 | Acetone | 0.5 | 70 |
| E4 | 140 | 56 | Acetone | 0.5 | 71 |
| E5 | 70 | 41 | Acetone | 2 | 80 |
| E6 | 70 | 56 | Benzaldehyde | 0.5 | 60 |
| E7 | 70 | 56 | Benzaldehyde | 2 | 72 |
| E8 | 70 | 56 | Di-tert-butyl peroxide | 1 | 70 |
| E9 | 70 | 56 | MIBK | 1 | 68 |
| E10 | 70 | 41 | 1,4-Cyclohexanedione | 2 | 72 |
| E11 | 70 | 56 | 1,2-Cyclohexanedione | 1 | 81 |
| E12 | 70 | 56 | 1,4-Naphthoquinone | 1.5 | 72 |
| E13 | 70 | 56 | 1,9-Cyclohexadecanedione | 2 | 74 |

*Percent by area from GC analyses

### EXAMPLES 14 TO 19 (E14-E19) and Comparative Experiments 5 and 6 (C5 and C6)

Dimethylchlorosilane (HM2) containing 1% by weight of the cocatalyst indicated in table 2 is metered by means of a metering pump and a mixture of 2.7×10⁻³ mol % of di-μ-chlorobis[(cycloocta-1c,5c-diene)iridium(1)] in allyl chloride and 0.5% by weight of the cocatalyst indicated in table 2 in a molar ratio of silane to allyl chloride of 1:1.05 is metered by means of another metering pump at a rate of 2 l/h (based on the total weight of the components fed in) into a continuous stirred vessel which has a reactor volume of 5 l and was maintained at 35° C. After the exothermic commencement of the reaction, the reactor contents are cooled over a period of 30 minutes to the target temperature indicated in table 2.

The yields of the target product obtained, viz. chloropropyldimethylchlorosilane (=ZP), and the amount of the by-products dimethyldichlorosilane (=M2) and dimethylpropylchlorosilane (=NP1) formed are indicated in table 2.

Comparative experiments C5 and C6 in which the reactor contents were not cooled down after the exothermic commencement of the reaction and the reaction proceeded at 80° C. or 60° C., respectively, display a significantly lower yield of the target product and an increase in the proportion of undesirable by-products.

TABLE 2

| | | | Temp. in | | | |
|---|---|---|---|---|---|---|
| | | | the | Yield | Amount | Amount |
| | HM2 | | reactor | of ZP¹⁾ | of M2²⁾ | of NP1³⁾ |
| | [kg/h] | Cocatalyst | in [° C.] | in [%]* | in [%]* | in [%]* |
| E14 | 1.9 kg/h = | Acetone | 27 | 94.0 | 4.0 | 2.0 |
| | 22 mol/h | | | | | |
| E15 | ditto | Acetone | 32 | 93.0 | 4.5 | 2.5 |
| E16 | ditto | Acetone | 35 | 91 | 5.5 | 3.5 |
| E17 | ditto | MIBK⁴⁾ | 27 | 94.2 | 3.8 | 2.0 |
| E18 | ditto | MIBK⁴⁾ | 30 | 93.5 | 4.5 | 2.0 |
| E19 | ditto | Di-tert- | 32 | 93.0 | 4.8 | 1.2 |
| | | butyl | | | | |
| | | peroxide | | | | |
| C5 | ditto | Acetone | 80 | 80 | 10.5 | 9.5 |
| C6 | ditto | Acetone | 60 | 85 | 8.0 | 7.0 |

*Figures are based on the percent by area from GC analyses and are normalized to the total chlorosilane content
¹⁾ZP = chloropropyldimethylchlorosilane
²⁾M2 = dimethyldichlorosilane
³⁾NP1 = dimethylpropylchlorosilane
⁴⁾MIBK = methyl isobutyl ketone

1-21. (canceled)

22. A process for preparing silanes of the formula I
R⁶R⁵CH—R⁴CH—SiR¹R²R³ (1),
comprising reacting silanes of the formula II
HSiR¹R²R³ (II),
with alkenes or alkynes of the formula III
R⁶R⁵C═CHR⁴ (III),
in the presence of at least one iridium compound catalyst and in the presence of at least one cocatalyst selected from the group consisting of
inorganic oxidants selected from the group consisting of oxygen, chlorine, bromine, iodine, peracids, peroxides, bromate, chlorate, iodate, perchlorate, potassium chromate, potassium dichromate, potassium permanganate, sodium peroxodisulfate, potassium perrhenate and potassium hexacyanoferrate(III);
metal-organic oxidants selected from the group consisting of ferricinium, [Ru(bipyridine)₃]³⁺ and [Fe(phenanthroline)₃]³⁺; and
organic oxidants selected from the group consisting of aldehydes, acetone, methyl isobutyl ketone, acetylacetone, 1,4-cyclohexanedione, 1,3-cyclohexanedione, 1,2-cyclohexanedione, 1,9-cyclohexadecanedione, benzyl, triketones, naphthoquinone, organic peroxides and peracids, crown ethers, phosphane oxides, sulfones, tritylium salts and tropylium salts,
wherein the cocatalysts are present in amounts of from 0.5% by weight to 5.0% by weight, based on the total weight of the components of the formulae (II) and (III),
where
R¹, R², R³ are each individually a monovalent Si—C-bonded, unsubstituted or halogen-substituted C₁-C₁₈-hydrocarbon radical, chlorine, or C₁-C₁₈-alkoxy radical,
R⁴, R⁵, R⁶ are each individually a hydrogen atom, a monovalent unsubstituted or F—, Cl—, OR—, NR₂—, CN— or NCO-substituted C₁-C₁₈-hydrocarbon, chlorine, fluorine or
C₁-C₁₈-alkoxy radical, where 2 radicals from among R⁴, R⁵, R⁶ together with the carbon atoms to which they are bound may form a cyclic radical,
or R⁴ and R⁵ can together represent a bond between the carbon atoms to which they are bound, and
R each individually is a hydrogen atom or a monovalent C₁-C₁₈-hydrocarbon radical.

23. The process of claim 22, wherein at least one of aldehyde, acetone, methyl isobutyl ketone, acetylacetone, 1,4-cyclohexanedione, 1,3-cyclohexanedione, 1,2-cyclohexanedione, 1,9-cyclohexadecanedione, benzyl, naphthoquinone or organic or inorganic peroxides are used as a cocatalyst.

24. The process of claim 22, wherein organic or inorganic peroxides are used as a cocatalyst.

25. The process of claim 22, wherein compounds of the formula IV
[(diene)IrX]₂ (IV),
wherein
X is a halogen atom, a hydroxy group or a methoxy group and diene is an unsubstituted or F—, Cl—, OR—, NR₂—, CN— or NCO-substituted C₄-C₅₀-hydrocarbon compound which has at least two ethylenic C═C double bonds, and
R is as defined in claim 1,
are used as iridium compounds.

26. The process of claim 22, wherein [(cycloocta-1c,5c-diene)IrCl]₂ is used as a catalyst of the formula IV.

27. The process of claim 22, wherein R¹, R², R³ individually are C₁-C₆-alkyl radicals or C₁-C₆-alkoxy radicals.

28. The process of claim 22, wherein R⁵, and R⁶ individually are C₁-C₆-alkyl radicals, chlorine-substituted C₁-C₆-alkyl radicals or C₁-C₆-alkoxy radicals.

29. The process of claim 22, wherein R⁴ is a hydrogen atom, a methyl radical or an ethyl radical.

30. The process of claim 22, wherein the process is carried out at a temperature of from 0° C. to 200° C.

31. The process of claim 22, wherein the process is carried out at a temperature of from 0° C. to 40° C.

32. The process of claim 22, wherein the process is a continuous process.

33. A process for the continuous preparation of silanes of the formula I
R⁶R⁵CH—R⁴CH—SiR¹R²R³ (1),
by the process of claim 1, comprising continuously reacting silanes of the formula II
HSiR¹R²R³ (II),
with alkenes or alkynes of the general formula III
R⁶R⁵C═CHR⁴ (III),
at a temperature in the range of 0° C. to 40° C., and the temperature of the reaction mixture is maintained at these temperatures.

34. The process of claim 33, wherein the reaction is started at a temperature of from 35° C. to 40° C. and after the exothermic reaction commences the reaction mixture is cooled to a temperature of from 20° C. to 30° C.

35. The process of claim 33, wherein the continuous process is carried out in a reactor selected from the group consisting of tube reactors, loop reactors, continuously operated stirred reactors, and combinations of these reactors.

36. The process of claim 35, wherein the reactors contain a cooling facility.

37. The process of claim 33, wherein a silane of the formula (II), optionally in admixture with the cocatalyst, is introduced into the reactor via one line and a mixture of alkene of the formula (III), catalyst and cocatalyst is introduced via another line.

38. The process of claim 33, wherein the silane of the formula (I) is discharged continuously from the reactor.

39. The process of claim 33, wherein at least one of aldehydes, acetone, methyl isobutyl ketone, acetylacetone, 1,4-cyclohexanedione, 1,3-cyclohexanedione, 1,2-cyclohexanedione, 1,9-cyclohexadecanedione, benzyl, naphthoquinone and organic or inorganic peroxides are used as cocatalysts.

40. The process of claim 33, wherein at least one organic or inorganic peroxides are used as cocatalysts.

41. The process of claim 33, wherein compounds of the formula IV
[(diene)IrX]₂ (IV),
where
X is a halogen atom, a hydroxy group or a methoxy group and
diene is an unsubstituted or F—, Cl—, OR—, NR₂—, CN— or NCO-substituted C₄-C₅₀-hydrocarbon compound which has at least two ethylenic C═C double bonds, and
R is as defined in claim 1,
are used as iridium compounds.

42. The process of claim 33, wherein [(cycloocta-1c,5c-diene)IrCl]₂ is used as catalyst of the formula IV.
